(19) United States
(12) Patent Application Publication
(10) Pub. No.: US 2014/0365354 A1
(43) Pub. Date: Dec. 11, 2014

(54) VISUALIZATION OF INDIVIDUAL TRUSTWORTHINESS SCORE

(71) Applicant: Rawllin International Inc., Tortola (VG)

(72) Inventor: Simon Shvarts, San Jose, CA (US)

(21) Appl. No.: 13/914,443

(22) Filed: Jun. 10, 2013

(51) Int. Cl. G06Q 40/02

(52) U.S. Cl. CPC G06Q 40/025
USPC 705/38

(57) ABSTRACT

Financial behaviors are analyzed for behavioral data to determine financial measures related to a trustworthiness score. A financial communication is facilitated in order to modify one or more behaviors. The financial measures are determined according to the financial behavior data and further information obtained from the financial communication. The financial communication drives behaviors to affect a real-time credit risk, and a visualization of alterations of financial measures and credit risk as direct feedback. The system demonstrates how behaviors and personal data identified affect credit risk. Based on the financial transactions and the communication exchange, estimates can be made of a financial score that comprises the financial measures, and further presented in a display.

### CROSS-REFERENCE TO RELATED APPLICATIONS

The subject patent application is related to co-pending U.S. patent application Ser. No. 13/615,053, filed on Sep. 13, 2012, entitled “Behavioral Based Score,” which is hereby incorporated by reference in its entirety.

### TECHNICAL FIELD

The subject application relates to observing behaviors and interpreting the behaviors to generate a behavioral based score.

### BACKGROUND

Personal digital assistants (PDA)s and other devices can often assist with unique needs such as in medicine, communication, and other areas of personal life. In the world of finance, people consult a number of different people for handling their investments, taxes, banking, and the like. While many of these areas market themselves to consumers, the consumer is left to educate, pursue and obtain information about their finances, the financial world, and resources available. For example, the average consumer has little knowledge of what is available for saving their money, utilizing their money efficiently, and understanding how their actions in the financial world impact their credit. Financial instruments (e.g., a loan, an investment account, a check book, title to property, etc.) and transactions involving them often require proof of employment and financial viability, such as a checking account and evidence of employment. Typically, the interest rate for such instruments can be high, due to the level of risk experienced by the lender. However, when a consumer needs to obtain a quick credit decision, there may be few alternatives if their credit is not what is expected.

Many different experiences, financial decisions, and financial conditions can affect a consumer's credit and also their finances. For example, consumers are frequently presented with opportunities to apply for instant approval for credit cards during internet shopping, or at the point of sale during traditional in-store shopping. Often the consumer can charge a current purchase to the new account if they are approved, and may be able to take advantage of one or more promotions for applying. However, consumers having little, or no, credit history are unlikely to be approved for these credit cards, such as with college students trying to start careers for the first time or groups of elderly always wary of credit. In addition, some consumers choose not to use credit cards, or elect not to go through the application process at the time that the offer is presented.

Moreover, retailers often attempt to persuade consumers to purchase additional items, or items related to items that the consumer is purchasing. In order to tailor the suggestions to the desires of the consumer, some retailers employ loyalty cards that enable the retailer to monitor the buying patterns of the consumer. Similarly, online retailers often encourage consumers to maintain a user account with the retailer, and data tracked via the user account can be used to suggest purchase options, or tailor promotions based on the consumer's buying patterns. However, the consumer is often unknowledgeable of the everyday affects and unbiased information regarding their credit.

The above-described deficiencies of today's credit application and promotional tools lend for the need to better serve and target potential clients. The above deficiencies are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for facilitating a financial communication, determining trustworthiness (e.g., a creditworthiness score or the like) from a set of behaviors and visualizing the financial measures dynamically are contained herein. An exemplary system comprises a memory that stores computer-executable components, and a processor, communicatively coupled to the memory, that facilitates execution of the computer-executable components. A behavior component is configured to analyze a set of financial behaviors to determine financial behavior data. An interaction component is configured to facilitate a financial communication related to a modification of the set of financial behaviors. A score component configured to determine a financial measure based on the financial behavior data and the financial communication. A visualization component is configured to visually render the financial measure in a display component.

In another non-limiting embodiment, a method comprises analyzing, by a system including at least one processor, a set of financial behaviors to determine financial behavior data. A trustworthiness score is determined as a function of financial measures related to the financial behavior data. Graphical indicators that correspond to the financial measures and the trustworthiness score are presented in a display.

In still another non-limiting embodiment, an exemplary apparatus, comprising a memory to store computer-executable instructions, and a processor, communicatively coupled to the memory, which facilitates execution of the computer-executable instructions. The processor facilitates execution of the computer-executable instructions to determine financial behavior data from a set of financial behaviors, initiate a financial communication related to modifying the set of financial behaviors, determine a financial measure based on at least one of the financial behavior data or communication responses received from the financial communication, and present a set of financial variables to the financial measure as graphical indicators in a display.

In still another non-limiting embodiment, an exemplary a tangible computer readable storage medium has computer executable instructions that, in response to execution by a computing system causes the computing system to perform operations. The operations can comprise analyzing a set of financial behaviors to determine financial behavior data. A set of recommendations related the set of financial behaviors is generated. A financial communication is communicated that has the set of recommendations for modifying the set of financial behaviors. The method includes presenting a set of graphical indicators that correspond to a set of financial measures based on the set of financial behaviors.

The following description and the annexed drawings set forth in detail certain illustrative aspects of the disclosed subject matter. These aspects are indicative, however, of but a few of the various ways in which the principles of the various innovations may be employed. The disclosed subject matter is intended to include all such aspects and their equivalents. Other advantages and distinctive features of the disclosed subject matter will become apparent from the following detailed description of the various innovations when considered in conjunction with the drawings.

### BRIEF DESCRIPTION OF DRAWINGS

FIG. 1 illustrates an example system in accordance with various aspects described herein;

FIG. 2 illustrates another example system in accordance with various aspects described herein;

FIG. 3 illustrates another example system in accordance with various aspects described herein;

FIG. 4 illustrates an example index component in accordance with various aspects described herein;

FIG. 5 illustrates an example view pane in accordance with various aspects described herein;

FIG. 6 illustrates an example view pane in accordance with various aspects described herein;

FIG. 7 illustrates a flow diagram showing an exemplary non-limiting implementation for a system in accordance with various aspects described herein;

FIG. 8 illustrates a flow diagram showing an exemplary non-limiting implementation for a system in accordance with various aspects described herein;

FIG. 9 is a block diagram representing exemplary non-limiting networked environments in which various non-limiting embodiments described herein can be implemented; and

FIG. 10 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon such as with a module, for example. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements. In addition, the term “set” refers to “one or more.”

### Overview

In consideration of the above-described deficiencies among other things, various embodiments are provided that dynamically interpret data related to clients for credit worthiness, and, more generally, visualize the data dynamically so that clients can better observe what affects their credit and undertake economic activities with greater knowledge. This disclosure relates to visualizing financial measures that affect a financial score such as a trustworthiness score, and to generating advice, guidelines and/or recommendations related to financial behavior, such as financial transactions, financial settings, financial savings, and/or any interaction that is financially related. Additionally, an interaction or a financial behavior that includes an interaction (e.g., exchange of goods or services, communications and the like) can be related to a client or consumer's habits, spending patterns, style of living, etc., in which financial behavioral data can be identified. For example, information can be obtained about the consumer patterns and life styles not only from his ledgers, but also from various other sources, including, but not limited to lifestyle data, a consumer/client profile, implicit questionnaires, analysis of consumer social network profiles, and other public online related data, such as an RSS feeds the client is subscribing to and TV shows he is watching online or online window shopping patterns or recent visits, and the like. From these transactions, financial behavioral data and communication exchanged with the client, a set of financial measures can be computed as they related to a financial score and visually rendered as graphical indicators for the user to dynamically observe.

The advice can be provided in the form of dialogues, conversations, and/or, in other words, exchanges based on a user's behavior and/or communication with the user to determine a recommendation/advice to improve or modify financial behavior. The financial behaviors of a suer can include a person's risk tolerance level, spending habits, goal setting, saving habits, payment history, financial attitudes towards each, and/or other behavioral indications (e.g., indicators) that relate to financial behaviors, financial habits, financial beliefs, and/or financial attitudes that relate to the set of recommendations.

In one example, graphical indicators can be provided to the user for viewing changes or a dynamic visualization of financial measures as they affect the user. The client can communicate concerns, financial conditions, and/or financial behavioral data (recent transactions, savings, debits and credits, rent, etc.) and a dynamic rendering of financial measures can be visualized on a client device. In addition, behaviors can be tracked via transactions by the device and used to provide recommendations, dynamically alter any of the financial measures and visually render these changes in the financial measures. A financial interaction is facilitated according to a transactional behavior and a financial communications engaged with the user, whose behavior can be tracked via communications with a transactional database or system component (e.g., a digital wallet, bank account aggregators, etc.) according to a user's preferences to better educate, serve and provide reward stimulus for engaging with digital financial assistance, while also visually representing the client's financial health.

To determine the credit worthiness of a client for a small loan, a large loan or some other financial instrument, information pertaining to the client's behavior is obtained by facilitating a financial interaction, such as an exchange, a dialogue, and/or a conversation with recommendations and determinations as to how the user acts upon the recommendations. A set of behaviors can include, for example, beliefs, actions related to various stimuli (e.g., better credit offers, improved credit rating options, savings tips, etc.), inputs and/or responses. The set of financial indicators can be ascertained from indicators (indications) that are identified throughout a financial communication and/or a financial transaction identified with a client. These indicators can be used to determine a set of financial scores (e.g., a trustworthiness score, a credit risk score, etc.) that are displayed from, during and/or throughout the interaction. The indicators can be utilized as a factor or as a basis to determine a credit worthiness score for the client interacting in the financial interaction and for further underwriting credit.

### Non-Limiting Examples of Visualization of Individual Trustworthiness Score

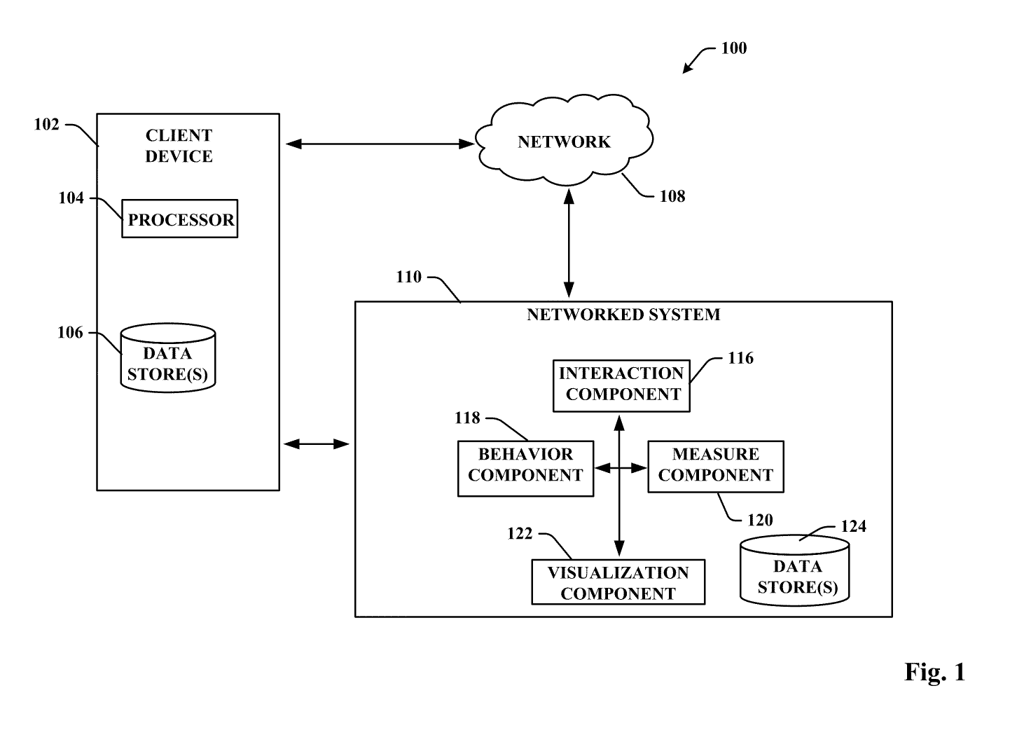

Referring initially to FIG. 1, illustrated is an example system 100 that outputs one or more visual measures of a financial score based on behaviors and communications related to a client's finances in accordance with various aspects described herein. The system 100 is operable as a recommendation system that can communicate with a client to increase a financial score, improve financial behavior that is related to, for example, financial goals, spending behavior, financial condition, investment recommendations, savings, credit, payment, etc., in order to improve the score and modify financial behaviors by rendering a dynamic visual indication of the client's financial health. The system 100 can operate further, for example, to recommend ways to increase one or more of the financial measures, to improve financial behavior that is related to financial goals, spending behavior, financial condition, investment recommendations, savings, credit, payment, etc., in order to benefit a client. The system 100 can also operate to recommend credit to potential clients, provide recommendations to third parties for underwriting credit or providing financial instruments, and/or provide other assistance in other personal areas and transactions as related to clients. The system can visualize various financial measures (e.g., a capacity measure, a collateral measure, a capital measure, an economic condition measures, a character measure, an advice measure, a risk measure and the like) in a display component (e.g., a display screen, a touch display, an interface display, and the like) for dynamically and continuously visualizing indications of financial trustworthiness.

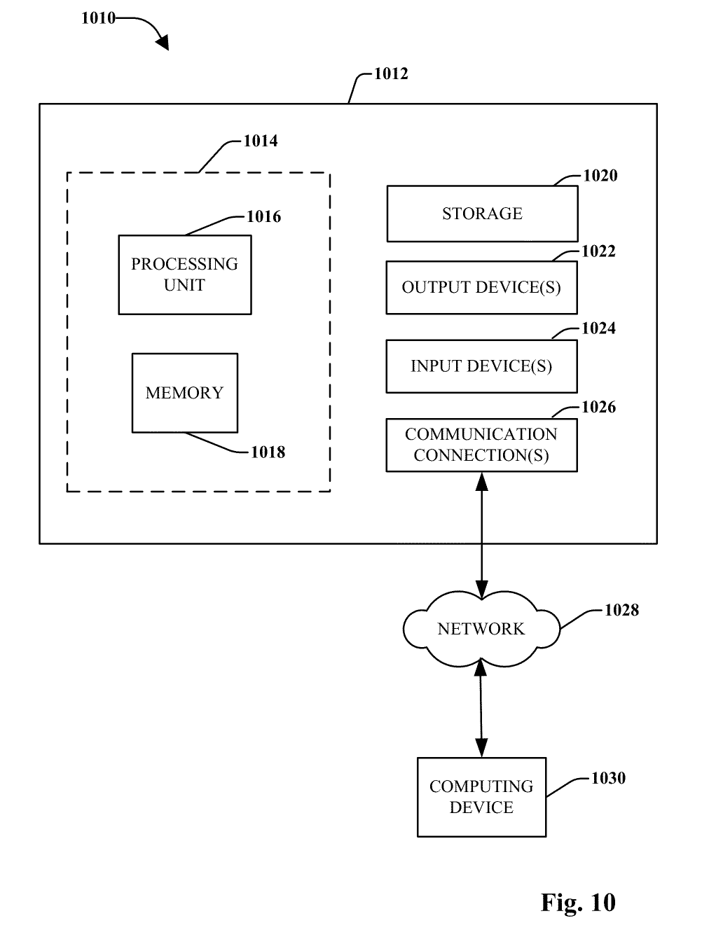

The System 100 can include a memory (e.g., data store(s) 106, 124, and the like) that stores computer executable components and a processor (e.g., processor 104, and/or any component) that executes computer executable components stored in the memory, further examples of which can be found with reference to FIG. 10. It is to be appreciated that the computer 1012 can be used in connection with implementing one or more of the systems or components shown and described in connection with FIG. 1 and other figures disclosed herein.

The system 100 includes a client device 102 that comprises a computing device, a mobile device and/or a mobile phone that is operable to communicate one or more messages via an electronic digital message (e.g., a text message, a multimedia text message, and the like) and/or a voice message with an audio output/input (e.g., speaker, microphone, etc.). The client device 102 includes a processor 104 and at least one data store 106 that processes and stores exchanges of a financial interaction (e.g., a set of conversations, exchanges, and/or interactions) as well as personal data analytics related to the client or user. The exchanges or behaviors observed can include a number of responses or behaviors of the client that can be generated and/or tracked from among one or more devices. For example, a set of dialogues, recommendations and/or a suggestions can be provided to a client that can include a set of questions, a set of answers, a set of statements, a set of declarations, a set of data, etc., that are exchanged during the interaction, and based on the responses and/or financial behaviors by the user, the system 100 can determine and/or update a financial measure score.

The client device 102 is operable to communicate multimedia content via the network 108, which can include a cellular network, a wide area network, local area network, and/or other type network. The client device 102 is further operable to communicate to other devices or systems, such as to a network system 110 via a network 108. The network 108 can also include a cloud network that enables the delivery of computing and/or storage capacity as a service to a community of end-recipients that entrusts services with a user's data, software and computation over a network. Additionally, the client device 102 can include multiple client devices, in which end users access cloud-based applications through a web browser, a light-weight desktop or mobile app and to resources of the networked system 110.

The system 100 includes the networked system 110 that is communicatively connected to one or more servers and/or client devices via the network 108 for receiving user input, gathering personal data in a user profile, identifying financial transactions by the user, and communicating with the client through a financial conversation or financial dialogue exchange. The network 108 is communicatively connected to the networked system 110, which is operable as a networked host to provide, generate and/or enable message generation on the network 108 and/or the client device 102 either directly or via the network 108.

The networked system 110 can further include an interaction component 116, a behavior component 118, a measure component 120 and a visualization component the personal data component 120, and is further configured to facilitate, analyze and generate feedback during a financial interaction (communication exchange of responses to communications and/or responses based on responses) with a client (e.g., client device 1020 and continuously provide feedback over various periods of time, at different points in time, or with respect to time. The network system 110 thus enables a user to establish and define a relationship with a digital associate, such as the system 110 by providing interaction back and forth based on one or more user defined preferences, personal data analytics, and identified behavior data related to financial transaction(s). The interaction component 116 is configured, for example, to facilitate dialogue, communication or conversation, such as a financial interaction to the client device 102. The financial interaction that is facilitated is based on communication exchanges, personal data, user preferences, and/or financial behaviors, such as whether the client or user follows advice or recommendations that are provided, a transaction that is being undertaken, past financial transactions, financial terms, product availability, financial status, etc., and information (e.g., personal data analytics, financial behavioral data, etc.) as it is learned, received or identified about the user. For example, the networked system 110 via the interaction component 116 can generate a set of dialogues, recommendations and/or suggestions that facilitate a conversation, otherwise known as a financial interaction, dialogue or exchange, which is related to financial behaviors of the user. The dialogue generated can be between the network system 110 and the client device 102, and/or only with the user device or networked system, in which interaction can occur between at least one user and dynamically with the interaction component 116. The interaction component 116 can facilitate dialogue through various means or multiple channels, such as a voice generated interaction, key pad interaction, chat interaction, iMessage, video (e.g., for sign language communication and the like) and/or interaction with various forms, questionnaires, responses, recommendations, etc., in which advice or suggestions provided to the client are then tracked, such as via a digital wallet, bank account aggregators, and other such information sources of financial data related to the client's behavior as discussed above.

In one example, a user interacts with the networked system 110 via the client device 102 through one or more channels for a conversation or voice exchange such as iMessage, voice exchange as operated by the interaction component 116. The interaction component 116 can dynamically respond to various responses, answers, statements, actual financial behavior, such as recent transactions, savings, debits and credits, rent payments and any other such financial related behavior associated with the client via the client device 102. The responses from the interaction component 116 can be recommendations or advice that includes options for improving the client's financial condition, statements, and/or questions to initiate a response or further conversation about the client or user's financial knowledge, condition, personality, user preferences and the like. For example, a question could be provided that is a closed ended question (e.g., eliciting yes or no answers), such as “Would you like to determine a financial score or measure a financial health, receive education or financial knowledge, a lower interest rate on a credit card, and/or register for auto-pay for one or more bills?” Other types of questions or options could also be provided to provide a set of financial recommendations, to indicate a user's behavior in response to the recommendations, collect data about preferences and/or personal data analytics, engage a financial communication related to financial behavior in financial transactions and/or communicate explanation of visual indicators provided by the visualization component 122, further discussed in detail infra.

In on embodiment, the interaction component 116 operates to converse, exchange and/or initiate dialogue with a client based on one or more user preferences, such as a tone (e.g., a voice tone, text language tone), a language, a gender, a voice (e.g., a celebrity voice or other type voice), a dialect and/or a grammar construction. A user can set the user preferences and the user preferences can be changed based on circumstances and data gathered from personal data analytics and personal behaviors identified. For example, where the user opens up an investment account, the interaction component 116 can operate to provide investment advice, knowledge about investment decisions, and/or other financial data based on the users income, interest, savings, and the like data about a financial condition of the user (e.g., any condition or behavior related to a financial transaction). The term financial transaction is intended to define any exchange or barter goods/services/payment.

Based on how the user follows a recommendation, suggestion, responds in conversation to questions, and/or advice, the system 100 is configured to determine a financial measure to dynamically rate (via the measure component 120) and present (via the visualization component 122) the measure to the client. For example, the financial measure can be a score, multiple financial measures as subcomponents or variables for determining a complete financial measure or score, an indicator, and/or indicators of each of the financial measures/variables. In addition, the interaction component 116 can provide options or recommendations in response to questions, such as open or closed ended questions, scenario options, data fields, etc., to further facilitate an interaction about a client's finances and “get to know” or ascertain knowledge of a financial and personal nature as a companion. For example, a question such as “Would the client like to provide savings in a savings account?”, “From what account would the client like to transfer money to a savings account?”, “What frequency would the client like to transfer money to a savings account?” “Would like to lower rent expense?” “Would you like a financial savings plan for yourself?” and other such financially related questions or options could be generated by the interaction component 116. Because behaviors, such as a client's financial behavior, can be a product of various beliefs, habits, and experiences, as well as abilities and means, the interaction is facilitated to gauge these sets of behaviors from personal data analytics that could be obtained from observation and communications (e.g., via the client device 102), and of the client's behavior as it relates to one or more financial transactions. For example, a user profile or psychological profile that includes various classifications to categorize and understand a user's behaviors can be stored and dynamically generated over time. From the user profile, a personal data component 120 can determine personal data analytics that tell information about a user's interest, preference, savings, spending and/or investment habits, whether the user is likely to deviate, risk tolerance for the user, as well as deviated behaviors or ways to stabilized behavior through increased knowledge. Once an overall profile or assessment is generated about a client's financial behavior, recommendations or advice can be further given for modifying the behavior, and a financial measure or score can be determined.

The behavior component 118 is configured to analyze the data obtained from the client device 102, a data store (e.g., data store 124) and/or some other device, component, network or system (e.g., a digital wallet, bank account aggregators, and the like). The behavior component 118 is configured to identify and/or determine financial behavior data from various data stores, conversational exchanges, and/or transaction data from financial transactions in order to determine various data indications of the client's behaviors and/or likes, dislikes, and/or general profile. The data can be a set of behavioral indicators related to the client's financial behavior, which can be used by the interaction component to make an assessment or objective measure of the client's behavior and/or personality towards his or her finances (e.g., via the client device 102).

The measure component 120 is configured to determine a financial measure based on the financial behavior data and/or the financial interaction/communication directly with the client device 102, and/or via communications with other parties (e.g., social networks, etc.) via the network 108. The financial behavior data and the personal data analytics can thus provide information, data or evidence that the client has, has not or in what manner the client has acted, is acting or will possibly act in accord with sound or healthy finances. For example, the set of behaviors can include skills, abilities, beliefs, knowledge, and the like for the client to have sound or healthy financial behavior. Personal data analytics can therefore be indications, probabilities, and/or classification that are negative, positive, or neutral, and can be used to provide a financial score or to measure the client's credit worthiness based on the financial score as well as indications of how a user will respond and what information could be pertinent to the user's financial condition for interactive dialoguing.

For example, if the networked system 110 can assess the responses provided by the client device 102 for competence to “make payments well,” “to save” etc., the behavior component 118 compares responses received from the client device 102 to an index of possible positive or negative key indicators (e.g., financial behavioral data, personal data analytics, user preferences, etc.) for competency in making payments well, saving, etc. An example of positive behavioral data can be a probability that the client makes payment obligations each month, pays obligations on time, does not get behind on payments, pays bills immediately, pays entire balance to avoid interest each month, has a predetermined number of bills that are paid (e.g., at least four, and under ten bills), as well as other such financial indications or indicators of various financial conditions, which can also be related to the behavioral criteria of the recommendations, suggestions and/or advice given to the client.

Negative indicators that can be related to a competency for “making payment well” that are analyzed by the behavior component 118 could be the opposite of the positive data, and also include other indications such as having too many or very few bills to pay. Making a minimum payment only could be a neutral indicator that could elicit a recommendation to double payments with a calculated amount of interest that would be saved to the client device 102. No one indicator or set of indicators are fixed, and any number of indicators related to financial conditions or states of behavior are envisioned to be utilized by the networked system 110.

In another example, the measure component 120 can measure various competencies for determining a trustworthiness score, and measured variables to compute the trustworthiness score. For example, via the financial behavioral data and the personal data (personal data analytics) from financial transactions, communications related to the financial transactions, and/or direct communications via the client device 102 with the interaction component 116, a saving variable can be measured based on the following: the client having a savings account, a percentage of savings being established, and/or a desire to save as indicated by answers to questions involving open ended, closed ended and/or scenario questions, and/or as indicated by tracking of a digital wallet, a bank aggregator or some other financial transaction system that tracks the user's financial behavior, and the like.

Based on the indications of how well the user's behavior corresponds to the set of recommendations, the financial behavior data obtained, and data from communicating with the client device, etc., a financial score can be computed with the measure component 120. For example, a financial score is initially calculated based on the client behavior data ascertained, and can then be additionally re-calculated after the advice is provided for adjusting, modifying or encouraging further behavior, such as a set of financial behaviors (e.g., transactions, payment plans, re-financing, etc.). The financial measure/scores can be further communicated (e.g., via text based message, voice, etc.) to the user via the client device 102, visualized via the visualization component 122, and communicate as well additional advice for further improvement and/or other financial information. The measure component 120 is also configured to base the computation of the user's financial score based on the user's behavior. The financial score can be computed also according to recommendations and/or degrees of correlation to the set of recommendations and the financial behavior monitored. After the advice is provided, the system continues to monitor behavior and continue the process of scoring the behavior, providing advice, determining the behavior, communicating with the client device 102 (e.g., voice controlled communications, text, etc. generated via the interaction component 116) further calculating or re-calculating the financial score, providing advice and continuing to determine financial behaviors and gather data regarding the client via the client device.

In one embodiment, the measure component 120 is configured to measure multiple the financial measures, in which the visualization component 122 operates to display in corresponding indicators as gauges, numbers, colors, life bars, needle gauges, metrics, a bit number, etc. The financial measures can comprise one or more of a reputation measure, a credit risk measure, a recommendation measure, a capacity measure, a collateral measure, a capital measure and/or a loan condition measure, in which one, two or more could operate as variables for determining a trustworthiness score or an overall financial measure as a function of the variables.

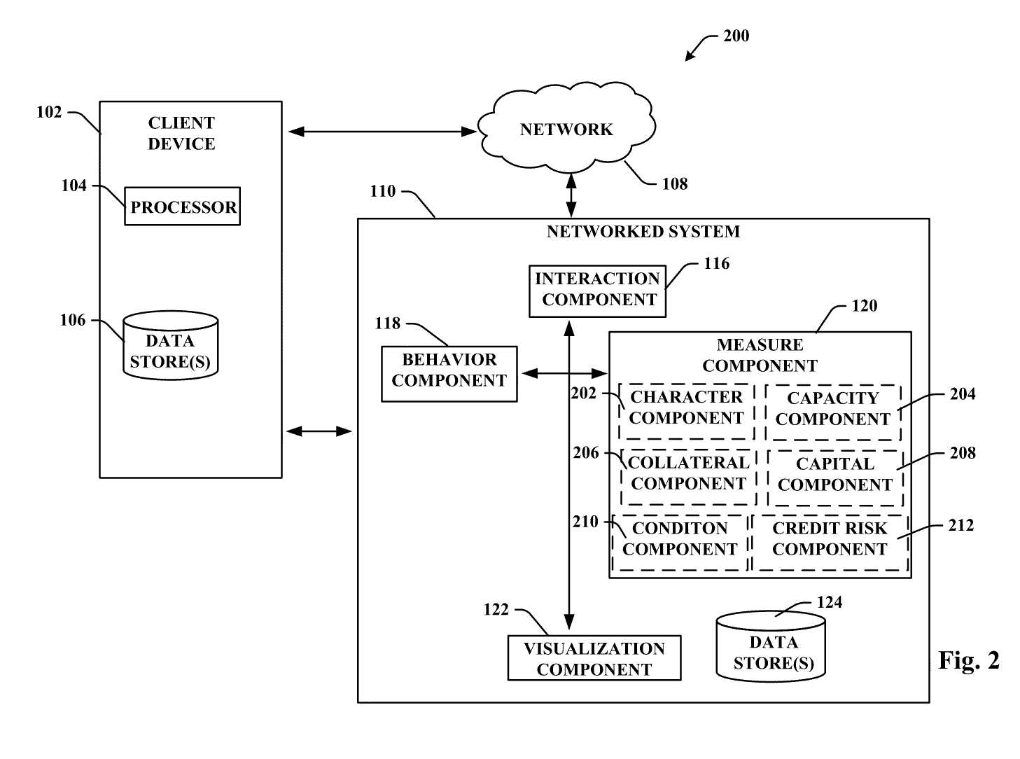

Referring to FIG. 2, illustrated is a system 200 in accordance with various embodiments disclosed. The system 200 comprises the networked system 110 with similar components as discussed above. The measure component 120 comprises a character component 202, a capacity component 204, a collateral component 206, a capital component 208, a condition component 210, and a credit risk component 212, in which each component can operate to compute one or more variables for determining an overall trustworthiness score and be rendered graphically in a display component via the visualization component 122. The measure component 120 can thus operate to use one or more (e.g., two or more) of the variables or associated measures of the variables as part of an overall financial measure or trustworthiness score, and/or as individual or separate indication for financial health.

The character component 202, for example, is configured to measure a set of character variables for determining a client's credit reputation as a reputation measure. The character variables, for example, can comprise a payment punctuality measure (e.g., making payments), a debt to credit ratio (e.g., amount of debts to available credit), a loyalty measure (e.g., a duration of credits/accounts holding), a quality of credit measure (e.g., bad debt or good debt based on a defined credit term amount), a credit variety measure (e.g., amount of credit diversity types), a criminal record measure (e.g., misdemeanor record or other criminal record) and/or a public filing measure (e.g., bankruptcies, liens, garnishments, etc.). The character variables can be measured based on a numerical score, a grade, a weight, a predetermined index score and/or other score or measure for rating or computing character variables for credit trustworthiness. For example, a payment punctuality measure can be determined based on a history for paying bills, a number of delinquencies, and the like. The loyalty measure can be based on how long a customer has been with a bank and willingness to pay debit, such as having the same credit account for a define period of time. A quality of credit can ascertain whether the debt of a user has is good credit or bad credit based on the terms involved. A credit variety measure determines the mix of credit a client has, such as new credit accounts and old credit accounts past a predetermined time frame.

The capacity component 204 is configured to measure a set of capacity variables of a capacity measure as part of the financial measure. The capacity variables can comprises one or more of an expense to income ratio (e.g., amount owed to an income amount), a payment to income ratio, a loan characteristic measure (investment debt, mortgage, revolving debt, 15-, 20-, 30-year fixed or variable, a balloon/reset mortgage, loan purpose, etc.), income source measure (investment, employment type, self-employed, salaried, support payment, etc.), a spending habit measure (amount of fluctuation of expenses, types of expenses, amount recurring, etc.), and/or a percentage of credit measure (e.g., an amount of debt kept revolving each month compared to total credit available).

The collateral component 206 is configured to measure a set of collateral variables of a collateral measure as part of the financial measure. The collateral variables/measures computed can comprise one or more an asset measure (e.g., total asset value, asset(s) value, total equity, down-payment amount, type of asset, etc.), a cash reserve measure (e.g., amounts available, liquid asset amount, etc.), property evaluation measure (e.g., appraised values), and/or an asset use measure (e.g., an intended use or purpose of the asset).

The capital component 208 is configured to determine a capital measure as part of the financial measure. The capital measure operates to particularly weigh an amount of capital put towards any potential investment. The more capital the less likelihood of default and greater potential for financial health in the long term for a client. The conditions component 210 is configured to determine a loan condition measure based on an economic status as part of the financial measure. Variables that are comprised by or function to determine the loan condition measure for trustworthiness assessment can include the types of use specified for credit, such as a business loan for blueberry farming. The market for blueberries could fluctuate cyclically, such as with steal or industrials, but with agricultural products the amount of revenue could fluctuate based on weather patterns, and/or other market conditions, for example. Overall predictions and associated weighting factors can comprise the condition measure by the conditions component 210, as well as the conditions of any one particular loan (or other financial instrument for a financial transaction), such as the interest rates and amount of principal that could influence a lender's desire to finance to the client (borrower).

The credit risk component 212 is configured to determine a credit risk measure as a function of the financial measure. The credit risk measure, for example, can be determine via one or more financial scorecards and/or rating factors/variables/measures as discussed. For example, an application scorecard can be used, along with behavioral scorecards, propensity scorecards, collections scorecards, as well as one or more ratings (e.g., public ratings, private rating based on the measures herein and/or visual indicators, etc.). The scorecard, for example, tries to predict the probability that the client, if given the product, would become “bad” within a given timeframe, incurring losses for the lender. The exact definition of what constitutes “bad” varies across different lenders, product types and target markets, however examples may be “missing three payments within the next 18 months” or “default within the next 12 months”. The score given to a customer can be an integer, such as a three or four digit integer, and can be proportional to the natural logarithm of the odds (or logit) of the customer becoming “bad”. A low score could indicate a low quality (a high chance of going “bad”) and a high score indicates the opposite. Other scorecard types may include behavioural scorecards—which try to predict the probability of an existing account turning “bad”; propensity scorecards—which endeavor to predict the probability that a customer would accept another product if offered one; and collections scorecards—which endeavor to predict a customer's response to different strategies for collecting owed money.

The above measures and variables can be determined independently and weighed according to any number of predetermined statistics or indexed scores for look-up by the measure component 120. Additionally, the variables/measures can be combined, factors/variables cross over into other measure or one another and/or used as variables for a trustworthiness score (as a function) and/or in ascertaining corresponding behavioral patterns for credit risk and risk tolerance levels. The visualization component 122 is further configured to alter the financial measures and/or variables based on a change in at least one indication that relates to the financial measure from the financial behavior data and/or from personal financial data obtained from the financial communications via the interaction component 116. The visualization component 122 can further display the changes via a display component (not shown), which is further discussed in detail below.

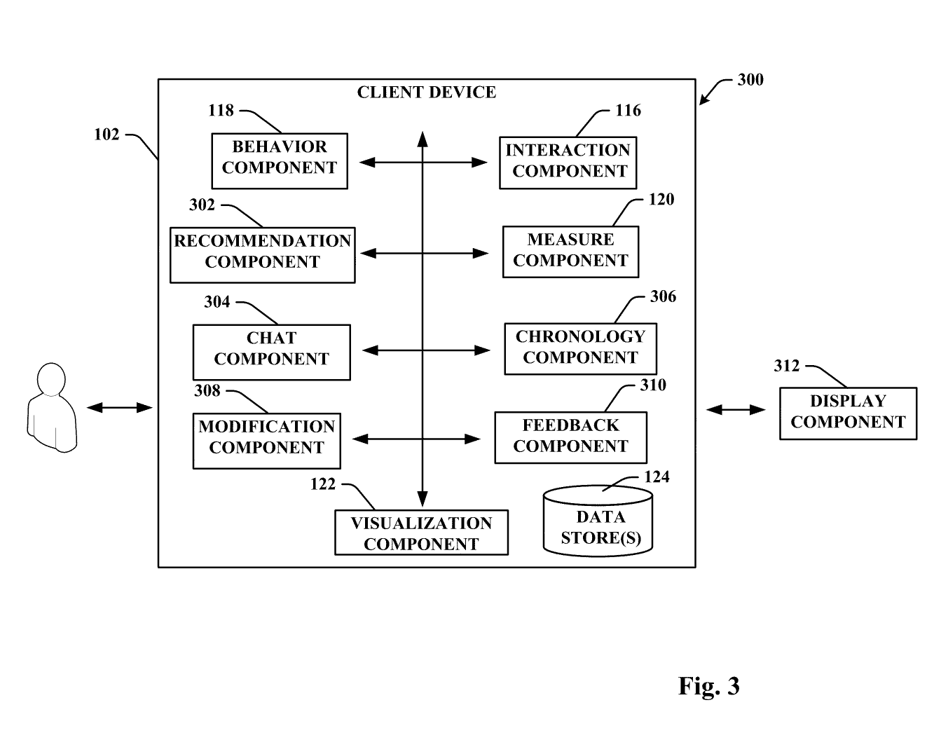

Referring now to FIG. 3, illustrated is an example system 300 that generates interaction with a client for financial health in accordance with various embodiments described. The system 300 is operable to output one or more recommendations pertaining to users or clients and generate a financial score based on behavior related to financial transactions and/or communications with the user by the interaction component 116. The system 300 generates visual indications of the financial health and further feedback for improving the financial well-being in a personalized, dynamic way to a client of a client device 102.

The system 300 includes the client device 102 comprising components discussed above and further comprising a recommendation component 302, a chat component 304, a chronology component 306, a modification component 308, a feedback component 310 and a display component 312, which operate to synergistically provide dynamic feedback visually and digitally in real time to a user (e.g., vocally, textually, video, imagery, and/or the like) in order to assess and educate towards greater financial health.

The recommendation component 302 of the client device 102 is configured to generate advice content related to behavioral responses received and/or financial behavioral data of financial behaviors related to one or more financial transactions. For example, advice on spending with different consequences that affect the financial measure/score from the measure component 120 can be provided by the recommendation component 302. The responses and/or financial behavioral data can be received as data from a financial conversation, interaction and/or transaction with a third party and/or directly with the client via the client device 102 or the interaction component 116. For example, a conversation or a portion of the financial interaction can occur with the interaction component 116 and a user, which could include, for example, the subject of savings, and be based and adapted on the responses received. The recommendation component 302 can generate a number of ways to save, increase savings, better save, and/or plan for savings that can be elaborated on according to further inputs received and/or on an updated financial condition (e.g., updated behavioral data related to finances, a transaction, personal activity, personal profile data obtained, etc.). A question could be provided, for example, whether the client believes saving is a top priority or goal, and a “yes” answer to setting up a savings account or other type savings account could incrementally raise the financial score of the client as dynamically displayed. In response to the yes, the client device 102 could inquire further into what the client would like to save for. If the answer is a short term benefit, a decrement to the user's score could be attributed to the score as a result of the behavior of uncontrolled delayed gratification associated with finances. A more long term savings plan would hint towards a more long term thinking client, which would be better prepared to invest money with, such as for a loan or the like. A series or set of behaviors and financial behavioral data identified can provide a more accurate financial score.

The chat component 304 is configured to transmit and receive at least one of textual dialogue, voice dialogue, video content and/or image content related to the financial interaction (e.g., a financial communication and/or financial behavior data from behavior of a financial transaction). For example, a user can view various selections, questions, statements, options, scenarios of financial situations, conditions and the like, chat with a live representative, view recommendations or financial advice tips during the interactive financial dialogue generated. The chat component 304 can generate a chat screen in order to facilitate various stimuli in the form of questions and answers sessions that facilitate interaction and enable the system 300 to ascertain indicators regarding the user's behavior, which includes the beliefs, knowledge, experiences that form the behavior in the user as relating to one or more financial transactions. The chat component 304 can generate a chat session that responds dynamically to a user with artificial intelligence logic, such as rule based logic, fuzzy logic and/or other artificial intelligence design. For example, a user can respond with concerns about saving money, and the system could focus questions, scenarios, and the like to generate indicators in order to measure or rate the behavior and how a credit score would correspond. The credit score, trustworthiness score, financial score and the like, for example, can be determined by the measure component 120 and be predefined based on the indicators matching conditions in an index with a like measure/score. The index measures/scores can be predefined based on real life data from people having similar scores with similar behaviors (i.e., behavioral characteristics) related to financial behavior, and/or analyzed based on another rating, which can weigh various indicators based on desired behavior and/or a level in which the behavior is encouraged or discouraged, for example.

In another embodiment, the system 300 is operable to generate multiple financial interactions via the client device 102. In some cases, for example, the client device 102 can undergo various financial interactions in order to increase their score and/or obtain a target score for credit worthiness. In this manner, the financial interactions generated by the interaction component 116, can operate as tutorials by which a client is able to learn better behaviors that can generate better scores. A user can undergo this process different ways such as by trial and error, a reverse mapping scheme, a chronology of financial scores mapped to a time line of the financial interaction, and/or through other like methods. A reverse mapping, for example, can provide an illustration of sample responses or behaviors within the financial interaction that could generate a target score that the user desires to obtain. For example, where the user answered or behaved in one way, other ways of answering various questions or behaving could be sampled to illustrate how to obtain a better score based on hypothetical financial behavior data. While multiple different behaviors, questions, responses and/or answers could be used to calculate a financial score, along with financial behavioral data related to observed financial transactions, during the course of a financial interaction by the scoring component 104, the reverse mapping could provide various samples of behaviors or answers that could generate a better score or a target score inputted via the client device 102.

In another embodiment, the chronology component 306 is operable to generate a chronology of the financial scores that are updated or altered throughout the financial interaction with the user. For example, answers, responses, and/or exchanges generated throughout the financial interaction can be mapped along a time line with corresponding financial scores that are generated in responses to indicators identified. In this manner, the user can see how certain behaviors affect financial health. Where certain areas of the dialogue are based on certain competencies or certain behaviors, the user can see where weaknesses and/or strengths could be.

The chronology component 306 is configured to generate a chronology of the financial measure with respect to time that is calculated from the financial behavior data and/or the financial communication, which can be displayed in the display component 312 via a text message, and/or dynamically on a display screen, for example. In one embodiment, the visualization component 122 can utilize the chronology component 306 to display a plurality of financial/indicators (indications) that are determined during or from financial behavioral data and/or financial communications (e.g., with other devices, systems, networks and/or the interaction component 116 of the client device 102). The chronology can, for example, be along a time line having time stamps where each indicator (e.g., visual indication of one or more financial measures/variables as discussed herein) is determined, or along any time interval. In addition or alternatively, graphical indicators can be presented with the financial measures/scores along the sequence of responses so that a user can see how particular interactions or responses can affect the financial score, and/or how particular behaviors related to a financial transaction affects the financial measure(s). In one example, a series of questions, scenarios and/or statements can be generated to dialogue with a client and each interaction in the series can be time stamped and illustrated along time lines along with financial scores related to each exchange or response received by the client. As scores are altered, and/or updated, the chronology component 306 can dynamically generate the time line or chronology with the financial scores during the financial interaction.

The modification component 308 is configured to modify at least one of a tone, a phrase, a language, a dialect, or a grammar construction based on a set of user preferences or personal data learned from the financial communication. The modification component 308 is configured to modify at least one of the user preferences according to an updated personal data analytic and/or an updated financial behavioral data throughout continued conversations and financial tracking with the client/user. The user preferences can include a tone (e.g., a voice tone, a text tone, etc.), a phrase, a language (e.g., English, Russian, etc.) a dialect (e.g., a regional accent, grammar construction, etc.) and/or a grammar construction. The modification component 308 can alter the user preferences, for example, according to the user's usage of language, dialect, etc. dynamically by receiving one or more inputs from the user that the modification component detects and/or detects from the voice input and/or other inputs received from a user during the course of conversational dialogue with the interaction component 116.

For example, a user could communicate with a southern accent from a geographical location or a global positioning system location, in which the modification component 310 can detect the variances and adapt to have a similar dialect and/or grammar construction as the user. Additionally or alternatively, the modification component 308 can receive inputs via a selection input from a user to predetermine the user preferences used by the client device 102 for conversation. A tone, for example, can include a voice level or a type of voice used (e.g., according to a gender, an age, deep vocal tones, soft vocal tones, and the like) in order to more personalize communications. Different dialects can utilize different vocal tones, different grammar usages, phrases and the like, which can also be selected, and/or detected to be dynamically modified to accommodate the user and detect a set of inputs or conversations exchanged with or by the user.

The feedback component 310 is configured to generate warnings that a certain type of move could detrimentally affect the financial score, in response to the score being lowered by a response that is a predefined difference. For example, in response to the client indicating that he or she would like to mortgage their home under an 80/20 loan/principal ratio, the system could generate that this would drop their financial score from 600 to 500, or some other difference in a range of scores.

The feedback component 310 is configured to generate warnings that a certain type of move could detrimentally affect the financial score, in response to the score being lowered by a response that is a predefined difference. For example, in response to the client indicating that he or she would like to mortgage their home under an 80/20 loan/principal ratio, the system could generate that this would drop their financial score from 600 to 500, or some other difference in a range of scores. An advantage of assessing financial risk or recommendation for credit on publicly available data is providing wider latitude to consumers needing such instruments. In particular, small business loans can be based on factors that do not require strict criteria, but can be assessed more heavily based on a person's behavior and behavioral modifications, which is ascertained from financial interactions with the customer.

A financial risk can further be determined via the client device 102 and shared with a third party, the client/user and/or used by the interaction component to provide a reward stimulus to the user. An advantage of assessing financial risk or recommendation for credit on publicly available data in addition to privately held data is providing wider latitude to consumers needing such instruments. In particular, small business loans can be based on factors that do not require strict criteria, but can be assessed more heavily based on a person's behavior and behavioral modifications, which is ascertained from financial interactions with the customer.

In another embodiment, the financial measures/scores can be determined from a combination of predefined scores matching different financial conditions, which can be pre-determinately weighted. For example, rating a behavior that indicates a low belief in saving money can be set to indicate a low financial score. The financial score can be based on a scale that can be similar to the scale for a credit score or can be based on a different range of numbers, which can have various ranges therein corresponding to excellent, good, mediocre, bad and/or terrible financial behavior. The measure component 120 is operable to determine and provide to the client device 102 a score based on one indicator and an updated score based on other indicators that are determined throughout the financial interaction.

The interaction component 116 can facilitate dialogue through various means, such as via live interaction among two parties, a voice generated interaction, key pad interaction, chat interaction and/or interaction with various forms, questionnaires, responses, recommendations, etc., in which advice or suggestions provided to the client are then tracked, such as via a digital wallet, bank account aggregators, and other such information sources of financial data related to the client's behavior.

In one example, a client can indicate by dialogue “I am planning to go on vacation, it is better if I plan it in advance and start setting money aside, and, here is my plan.” In return, recommendation component 302 can generate a set of preventative recommendations that operate on a future behavior indication compared to an observed past behavior that generates an advice, such as “don't take that loan for holidays, take this”. Positive reaction to both recommendations is improvement to the financial score, while one, such as the former, can be weighted to produce a higher grade for the user accordingly.

In another embodiment, a recommendation measure can be generated by the recommendation component 302 and visually rendered as a financial measure via the visualization component 122. Based on how the user follows a recommendation, suggestion and/or, otherwise, and advice, the system 300 is configured to determine a financial score. In addition, the recommendation component 302 can provide options or recommendations in response to questions, such as open or closed ended questions, scenario options, data fields, etc., to further facilitate an interaction about a client's finances for determining indicators to the client's behavior. For example, a question such as “Would the client like to provide savings in a savings account?”, “From what account would the client like to transfer money to a savings account?”, “What frequency would the client like to transfer money to a savings account?” and other such financially related questions or options could be generated by the interaction component 116. Because behaviors, such as a client's financial behavior, can be a product of various beliefs, habits, and experiences, as well as abilities and means, the system gauges these sets of behaviors from indicators (or indications) of the client's behavior. Once indicators are determined about a client's financial behavior, recommendations or advice can be further given for further modifying the behavior, and a financial score can be determined in response to the user's actions in relation to and how correlated the actions are to the recommendations generated.

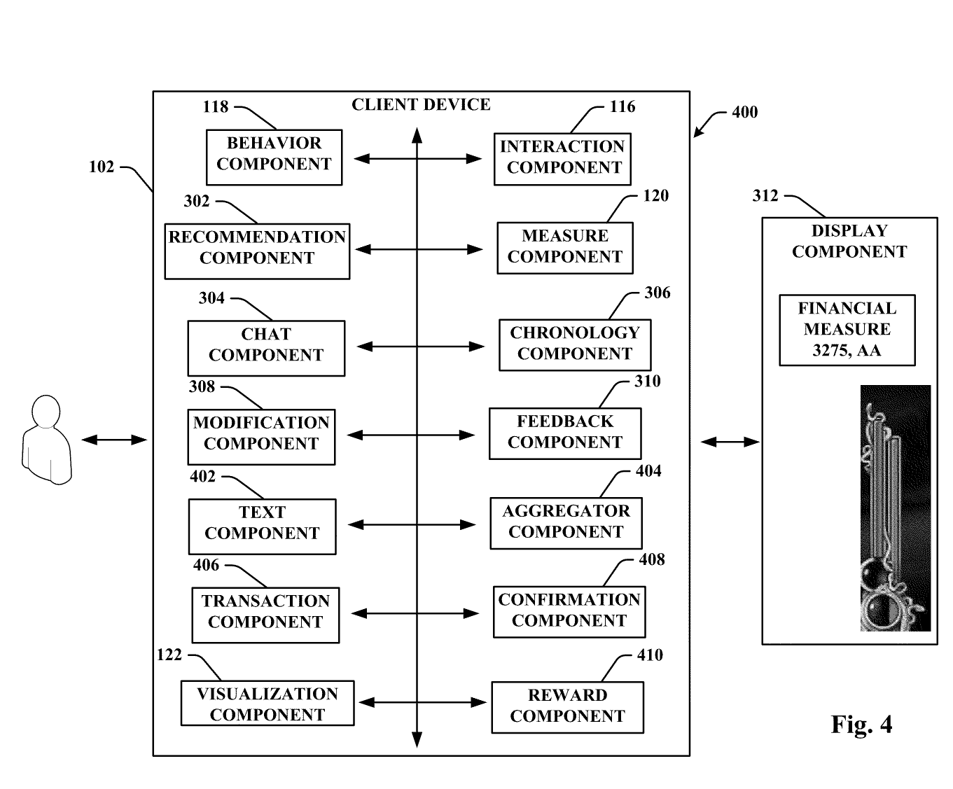

Referring now to FIG. 4, illustrated is an example system 400 in accordance with various embodiments described. The system 400 includes the client device 102 as one example architecture, in which the client device 102 further comprises a text component 402, an aggregator component 404, a transaction component, a confirmation component 408, and a reward component 410.

The text component 402 is configured to communicate financial transaction(s) in a text based message (e.g., such as via short message service (SMS), multimedia message service (MMS) and/or the like) to a mobile device. The text based message or other digital type message or display rendering via the visualization component 122 can include a transactional history feed of the one or more financial transactions. The financial transactions that are a part of the transactional history feed can be grouped in a grouping according to a set of contacts, via subject matter categories and/or other grouping. The set of contacts, for example, can comprise one or more counterparties that correspond to and/or participated in the one or more financial transactions. The grouping can be determined, for example, according to a user selection for a subject category grouping or a contact grouping. The transactional history feed can comprise a subset of the one or more transactions corresponding to a range of dates and/or a range of times based on a different user selection, such as a data selection via a user swipe being received at the display component 312.

The aggregator component 404 is configured to generate a transactional history feed of the one or more financial transactions that is grouped by a grouping according to a set of contacts comprising counterparties to the one or more transactions or according to a set of subject categories of the one or more financial transactions. Additionally or alternatively, the aggregator component 404 operates to publish visual graphical indicators to a client that correspond to the financial measures assessed dynamically based on the user preferences. For example, the feed could be a transaction history feed that comprises one or more transactional parties to the financial transactions identified relating to the client financial behaviors. The feed could include one or more subject categories identified the subject matter of each of the transactions. The feed can also comprise a graphical transactional history feed that has the chronology of indictor/measure changes and the current graphical indicators of each financial measure (e.g., a correlation measure of recommendations to behavior, capacity measure, character measure, collateral measure, capital measure, condition measure, credit risk measure, trustworthiness score/financial score, and/or the like). For example, as discussed above, each graphical indicator can be represented by a life bar, a number, a grade, a colour shade, a gauge, a needle gauge, a graphical user interface dial gauge, a bit number, and/or the like.

In one embodiment, the system 400 is operable to quantify and qualify a result of following or not following the recommendation by establishing an algorithm (set of processes) for a ratio of dependencies between monthly, pay-cheque to pay-cheque, quarterly, and/or annually income and debt/expense. For example, the advice or recommendations could be to “follow this suggestion to increase ratio to 5-3 from current 5-1”. If end result by the user produces 5-4—above the suggested then a financial score can equal AA+, or other numerical, alphabetic or alphanumeric score. For example, a 5-2 is better than it was, but not as good as suggested so the financial score could equal BB. By way of further example, a series of life gauges or bars that range from full to empty as a graphical control or user interface to dynamically illustrate current strength and/or weakness of a corresponding financial measure related to the client's financial health. Each graphical indicator could further be colored based on a weight or priority rating that is assigned to it in the calculation of a trustworthiness score or financial score. Because financial score calculations can vary, the indicator weights could also vary in the calculation of the financial score depending upon a type of transaction and/or client reason received for the computation. Likewise, the colors indicating weights to each indicator can also change. In this manner, a dynamic visualization and explanation of the indications can be communicated and kept up to date in conjunction with the client's financial status at any point in time.

The transaction component 406 is configured to generate a payment field within the text based message corresponding to a contact of the set of contacts, and to initiate a payment within the payment field via the text based message. For example, a visual rendering of the transactional history can be provided, in which the client can select at least one of the contacts, through either grouping (e.g., the contact grouping or the subject category grouping) and initiate a transaction to that contact for any specified amount. A transfer of funds, for example, can originate from the client's account through a network connection and/or through responding to the text based message to a banking network/server. Selection of the contact and providing an amount, can therefore provide a quick and easy way to fund transfer and make purchases, either online based on past transactions and/or in a store without have to pull out a credit card, check and/or cash. For example, the product could be paid for online via a network without having to provide a cash register any other item. The register worker observes over the network that a payment was made and a confirmation receipt or other confirmation is provided to the client digitally via an additional text based message or another digital message.

The confirmation component 408 is configured to generate a confirmation message of the payment processed to the contact selected, and/or the client device 102 in response to receiving confirmation that a payment has been processed via the text based message. Alternatively or additionally, a confirmation of payment transfer initiation could be generated by the confirmation component 408 in response to the text based message being responded to with a contact selection for an exchange of funds.

In another embodiment, the feedback component 310 is further configured to generate a feedback field for the text based message to receive and publish feedback to the set of contacts and/or the one or more financial transactions from the text based message. Therefore, an instantaneous review, and/or feedback of the transaction, the vendor, and/or services rendered during the transaction along with a comment sections, and the like could be provided via the text based message. In addition or alternatively, the reward component is configured to generate a rewards field of the text based message that communicates a reward stimulus from a contact of the set of contacts based on the one or more transactions and/or from the banking server servicing the client's accounts, for example.

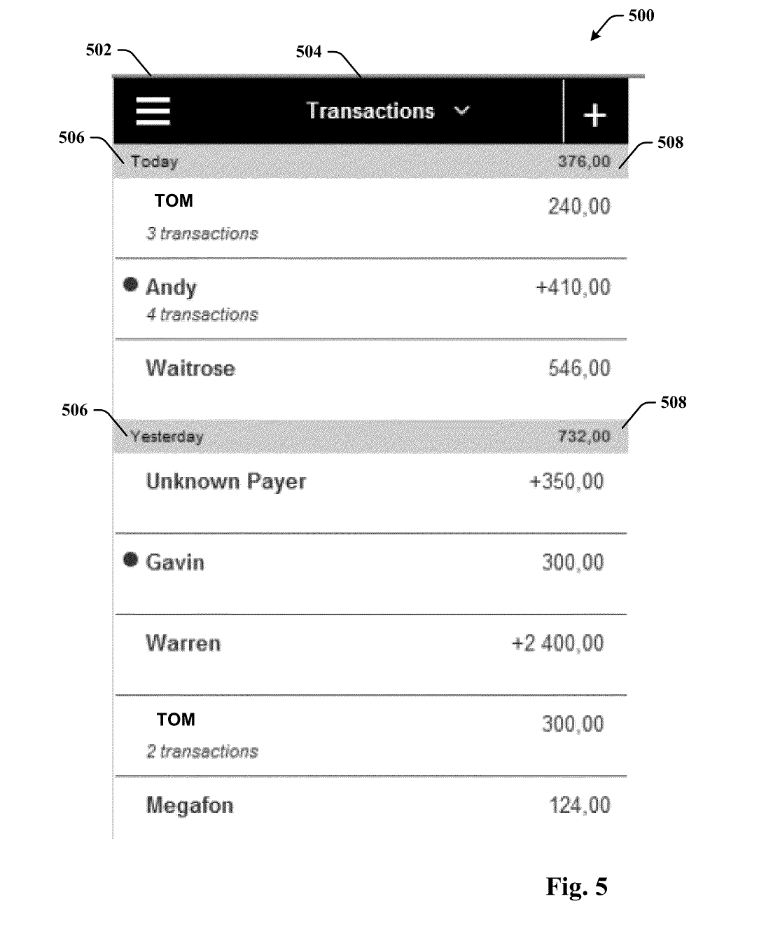

Referring to FIG. 5, illustrated is an example view pane 500 of a client device in accordance with various embodiments described herein. As discussed above, a financial score can be presented, for example, from various indications or graphical indicators that are determined from the client device 102 (e.g., mobile device, a digital wallet, bank account aggregator and/or the like). The systems disclosed herein are configured to receive a set of inputs based on the financial communications and/or identified behaviors in financial transactions, in which the set inputs can include indications/measures of whether and/or how the client has behaved according to various behavioral criteria, such as following a financial advice, financial variables discussed above and/or in what ways the client has behaved financially. The inputs or interactions can be further analyzed to ascertain a measured financial score, such as a financial score for the user to view dynamically over the course of conversations with the client via the client device 102 and/or financial transactions over time.

The view pane 500 includes a setting interface control 502 that operates to receive one or more user selections. A transactions interface control 504 operates to view summaries of the transactions according to dates, and/or view the transactions in a transactional history feed according to a set of options comprising a contact view that organizes the transaction parties as contacts and/or according to a set of subject categories that organizes the transactions and transactional parties according to subjects. The party involved in a transaction (e.g., Tom, Andy, Waltrose, Gavin, etc.) can be identified under each view (contact view and/or subject category view). Information about the transaction, such as amounts exchanged, total amounts 508, dates, time frames, etc. for a subset of transactions can be viewed.

In addition, a chronology of financial health measures can also be viewed under the settings to track financial health, recommendations at any point in time along the chronology provided by the recommendation components, and/or financial measures corresponding to graphical indications associated with each. A trustworthiness score can also be display, which is computed as a function having different financial measures as variables integrated as differential equations and/or integrations with respect to time or any of the variables of the trustworthiness function or modeling equation for the client.

In an embodiment of the view pane 500, the contact (transactional counterparties) and associated transactions can appear or resemble a list displayed in a text based message of a telephone history on a mobile phone. Names of banking transaction contacts stored as banking counterparties to one or more transactional exchanges and amounts involved with a given transaction can be displayed in either a view pane of a screen, and/or within a text based message as part of a continuously updated or period transactional history feed generated by one or more aggregator components. The transactions and summaries associated with each transaction can be organized further according to dates and/or time frames. For example, a division of days can be used as the chronology of financial transactions and associated contact parties. In another embodiment, if more than one transaction is engaged in on the same date, the transactions and corresponding parties, in which data is saved in a cloud network, the device and/or other network/server, are grouped together and totals exchanged indicated as a number amount.

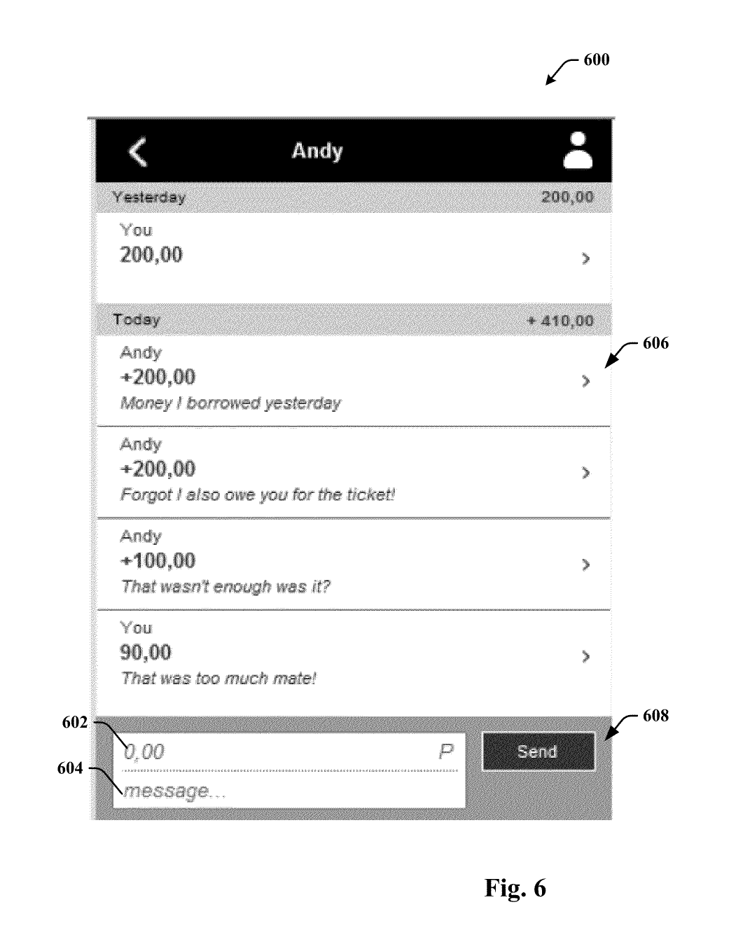

For example, the view pane 500 illustrates a transaction history feed in the form of a conversational text based message format and that is updated via text based messaging and/or other digital formatting service or protocol. The client device 102, for example, can receive a user input to initiate display of a list of transaction filtered by the contact in the form of a conversation or a conversational thread (a series of responses related to the same matter or subject). For example, by clicking on Andy the transactional history and related summarizing data can be viewed in the feed view pane, as illustrated, for example, in FIG. 6. In addition, a transactional section for implementing additional transfers or transactions with the same party through the transactional feed and/or via text based message responses are facilitated and described below.

Turning to FIG. 6, illustrates another example of a view pane 600 in accordance with various embodiments of this disclosure. Andy and the client's interactions financially are recorded and displayed in a transactional history feed 606 of a text based message and/or as an interactive display rendered by the visualization component described herein. The feed 606 comprises a transactional field section 608 that is configured to implement additional transactions or transfers of capital with the same party through the transactional feed and/or via text based message responses.

For example, the text based message and/or transactional feed can display links to the banking transactional history on the client device. The links, which comprises the past transactional parties, and/or entered transactional parties, can be selected and a payment amount can be entered into a payment field 602 along with any additional text message in a text based field 604 of the transactional field section 608. Depending upon configuration settings and the like, a PIN or personal identification number/code can be utilized in the transaction, and/or any other security as one of ordinary skill in the art can envision. In response to receiving a send input, the amount and message is sent to the account of the individual as a text based message and a payment. The text based message can include and/or be followed by a confirmation text, which can be sent by the client device 102 and/or the banking entity involved in the transactions.

A client or user device can zoom into further details based on dates (e.g., daily, weekly, monthly, and/or annually). Each of the views can show totals of transactions (e.g., year total, etc.) and/or contact details related to the specified range of time. The messaging field 604 can include one or more personal messages to the payee from the payor client, and/or operate as a memo field on a check. In addition, a review of the transaction, transactional party and/or services that is marked as feedback could be also provided.

In one example, a client is operable to check out a grocery or other store, provide exchange or shopping online, and/or generate banking transactions over a client device and/or personal mobile device. A phone can be used to provide a credit payment, a debit payment and/or an immediate cash transfer by a text based message and/or a transactional history feed, in which past transactional contacts and/or entered transactional party data is utilized for fast and efficient transfers. The client device thus serves to track, implement, and provided feedback on the transactional behaviors and financial health of the user.

While the methods described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

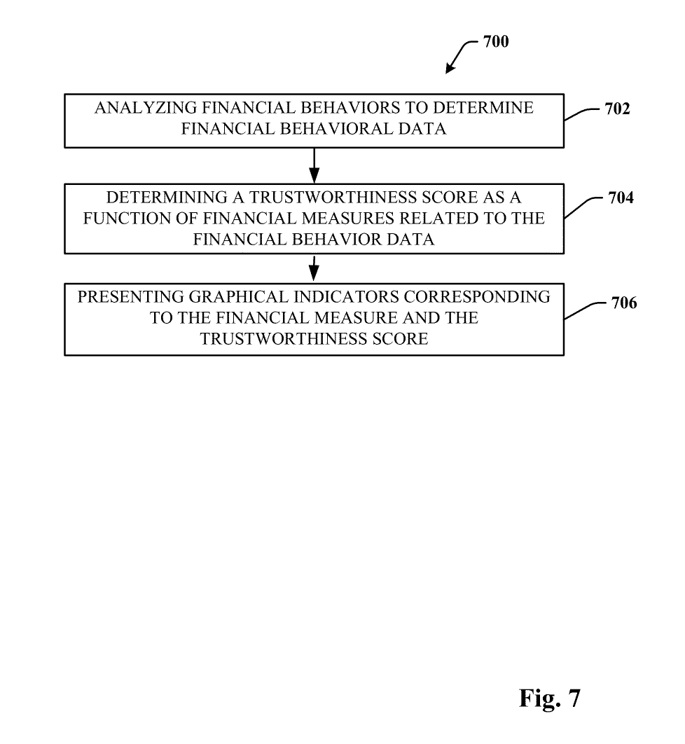

An example methodology 700 for implementing a method for a system is illustrated in FIG. 7. Reference is made to the figures described above for ease of description. However, the method 700 is not limited to any particular embodiment or example provided within this disclosure.

FIG. 7 illustrates the exemplary method 700 for a system in accordance with aspects described herein. The method 700, for example, provides for a system to interpret a financial interaction to determine one or more financial measures/scores from the interaction based on a set of financial advice or recommendations, while also identified, enabling and measuring various behaviors in financial transactions. At 702, the method 700 comprises analyzing a set of financial behaviors to determine financial behavior data (e.g., data about the financial measures and/or actions of the client either via a client device that interacts dynamically with the client). The financial transactions can be tracked, presented to the user and/or organized for the analysis of financial behavioral data or behaviors as they related to financial measures/variables and the like, as well as implemented further with additional transactions via the device.

At 704, a trustworthiness score is determined as a function of financial measures related to the financial behavior data.

At 706, graphical indicators are presented in real time corresponding to the financial measures and the trustworthiness score in a display.

The method can further include facilitating a financial communication related to modifying the set of financial behavior, and comprising a set of exchanges having received communication responses and transmitted communication responses based on the received communication responses. The financial communication can also be based on personal data obtained about the user's finances, either through communication between the user and the user device and/or based on other conversations/communications with the user over a network to other entities (e.g., a social network, bank server communications and the like). The client device further operates to modify at least one of a tone, a phrase, a language, a dialect, or a grammar construction based on personal data learned from the financial communication, and/or user preferences to be a dynamic personal financial companion.

In one embodiment, the method 700 can also include presenting a change in at least one of the graphical indicators corresponding to the financial measures with an explanation of the change with the at least one of the graphical indicators. The financial communication can further be facilitated by communicating based on at least one of the graphical indicators changing according to a change in the financial behavior data and/or personal data obtained from the financial communication.

In one example, the financial measures can comprise a reputation (i.e., character) measure, a credit risk measure, a recommendation measure, a capacity measure, a collateral measure, a capital measure and/or a loan/economic condition measure. The communication can further comprise communicating a textual dialogue (e.g., text based message) related to the financial behavior data. In addition, the communication can comprise presenting a recommendation measure in the display with at least one of the graphical indicators as a function of the set of financial behaviors corresponding to the financial recommendation. The graphical indicators comprise at least one of a visible gauge, a color, a bit number, or a bar indicator. The financial communication can also comprise communicating textual dialogue with g a set of financial transactions related to the financial behavior data in a text based message. For example, the text based message includes a transactional history feed of the set of financial transactions grouped by a grouping according to a set of contacts comprising counterparties to the set of financial transactions or according to a set of subject categories of the set of financial transactions, in which the grouping can be determined based on a user selection. The communications can further include communicating a payment field via the text based message, in order to initiate a payment via the text based message based on a different user selection to a contact.

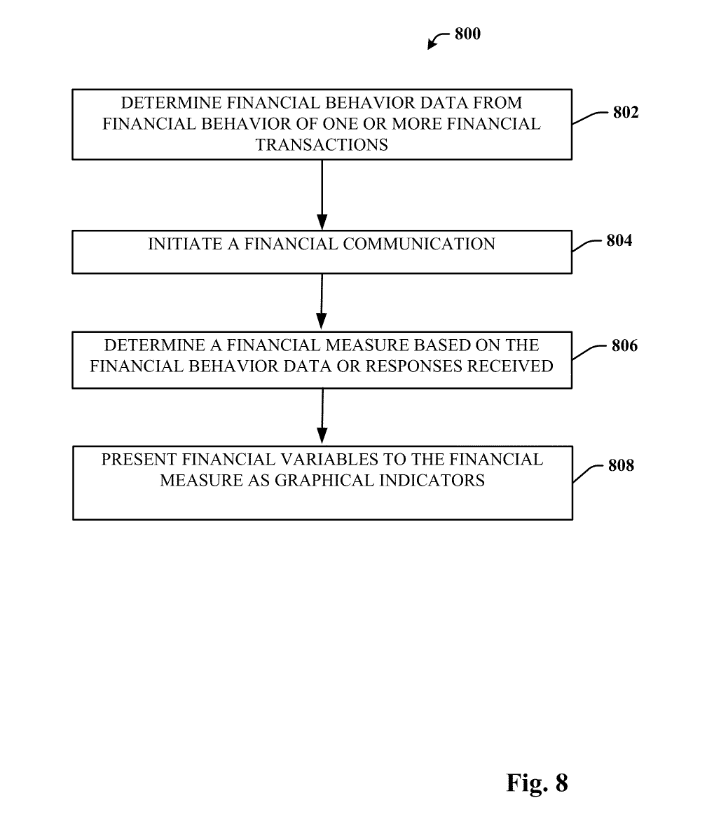

An example methodology 800 for implementing a method for a system in accordance with various embodiments herein is illustrated in FIG. 8. Reference may be made to the figures described above for ease of description. However, the method 800 is not limited to any particular embodiment or example provided within this disclosure.

The method 800, for example, comprises, at 802, determining a financial behavior data from a set of financial behaviors related to a set of financial transactions. At, 804, a financial communication related to modifying the set of financial behaviors is initiated. For example, one or more recommendations can be communicated based on the financial behavior data. At 806, a financial measure is determined based on at least one of the financial behavior data or communication responses received from the financial communication. At 808, a set of financial variables to the financial measure is presented as graphical indicators in a display component, in which term set as used herein comprises or is used as “one or more.”

### Exemplary Networked and Distributed Environments

One of ordinary skill in the art can appreciate that the various non-limiting embodiments of the shared systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

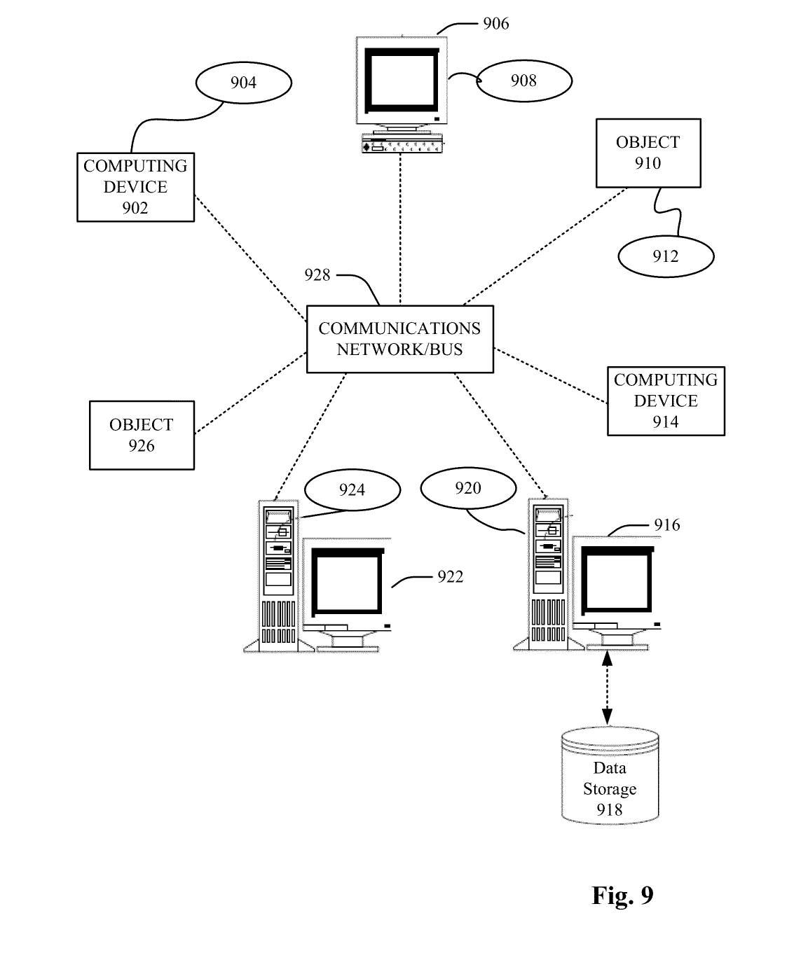

FIG. 9 provides a schematic diagram of an exemplary networked or distributed computing environment. The distributed computing environment comprises computing objects 910, 912, etc. and computing objects or devices 920, 922, 924, 926, 928, etc., which may include programs, methods, data stores, programmable logic, etc., as represented by applications 930, 932, 934, 936, 938. It can be appreciated that computing objects 910, 912, etc. and computing objects or devices 920, 922, 924, 926, 928, etc. may comprise different devices, such as personal digital assistants (PDAs), audio/video devices, mobile phones, MP3 players, personal computers, laptops, etc.

Each computing object 910, 912, etc. and computing objects or devices 920, 922, 924, 926, 928, etc. can communicate with one or more other computing objects 910, 912, etc. and computing objects or devices 920, 922, 924, 926, 928, etc. by way of the communications network 940, either directly or indirectly. Even though illustrated as a single element in FIG. 9, communications network 940 may comprise other computing objects and computing devices that provide services to the system of FIG. 9, and/or may represent multiple interconnected networks, which are not shown. Each computing object 910, 912, etc. or computing object or device 920, 922, 924, 926, 928, etc. can also contain an application, such as applications 930, 932, 934, 936, 938, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 9, as a non-limiting example, computing objects or devices 920, 922, 924, 926, 928, etc. can be thought of as clients and computing objects 910, 912, etc. can be thought of as servers where computing objects 910, 912, etc., acting as servers provide data services, such as receiving data from client computing objects or devices 920, 922, 924, 926, 928, etc., storing of data, processing of data, transmitting data to client computing objects or devices 920, 922, 924, 926, 928, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 940 or bus is the Internet, for example, the computing objects 910, 912, etc. can be Web servers with which other computing objects or devices 920, 922, 924, 926, 928, etc. communicate via any of a number of known protocols, such as the hypertext transfer protocol (HTTP). Computing objects 910, 912, etc. acting as servers may also serve as clients, e.g., computing objects or devices 920, 922, 924, 926, 928, etc., as may be characteristic of a distributed computing environment.

### Exemplary Computing Device

As mentioned, advantageously, the techniques described herein can be applied to a number of various devices for employing the techniques and methods described herein. It is to be understood, therefore, that handheld, portable and other computing devices and computing objects of all kinds are contemplated for use in connection with the various non-limiting embodiments, i.e., anywhere that a device may wish to engage on behalf of a user or set of users. Accordingly, the below general purpose remote computer described below in FIG. 12 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 10 and the following discussion provide a brief, general description of a suitable computing environment to implement embodiments of one or more of the provisions set forth herein. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1010 comprising a computing device 1012 configured to implement one or more embodiments provided herein. In one configuration, computing device 1012 includes at least one processing unit 1016 and memory 1018. Depending on the exact configuration and type of computing device, memory 1018 may be volatile (such as RAM, for example), non-volatile (such as ROM, flash memory, etc., for example) or some combination of the two. This configuration is illustrated in FIG. 10 by dashed line 1014.

In other embodiments, device 1012 may include additional features and/or functionality. For example, device 1012 may also include additional storage (e.g., removable and/or non-removable) including, but not limited to, magnetic storage, optical storage, and the like. Such additional storage is illustrated in FIG. 10 by storage 1020. In one embodiment, computer readable instructions to implement one or more embodiments provided herein may be in storage 1020. Storage 1020 may also store other computer readable instructions to implement an operating system, an application program, and the like. Computer readable instructions may be loaded in memory 1018 for execution by processing unit 1016, for example.

The term “computer readable media” as used herein includes computer storage media. Computer storage media includes volatile and nonvolatile, removable and non-removable media implemented in any method or technology for storage of information such as computer readable instructions or other data. Memory 1018 and storage 1020 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer storage media may be part of device 1010.

Device 1012 may also include communication connection(s) 1026 that allows device 1010 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” as used herein includes computer readable storage media and communication media. Computer readable storage media includes volatile and nonvolatile, removable and non-removable media implemented in any method or technology for storage of information such as computer readable instructions or other data. Memory 1018 and storage 1020 are examples of computer readable storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1010. Any such computer readable storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” may also include communication media. Communication media typically embodies computer readable instructions or other data that may be communicated in a “modulated data signal” such as a carrier wave or other transport mechanism and includes any information delivery media. The term “modulated data signal” may include a signal that has one or more of its characteristics set or changed in such a manner as to encode information in the signal.

Device 1012 may include input device(s) 1024 such as keyboard, mouse, pen, voice input device, touch input device, infrared cameras, video input devices, and/or any other input device. Output device(s) 1022 such as one or more displays, speakers, printers, and/or any other output device may also be included in device 1012. Input device(s) 1024 and output device(s) 1022 may be connected to device 1012 via a wired connection, wireless connection, or any combination thereof. In one embodiment, an input device or an output device from another computing device may be used as input device(s) 1024 or output device(s) 1022 for computing device 1012.

Components of computing device 1012 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1012 may be interconnected by a network. For example, memory 1018 may be comprised of multiple physical memory units located in different physical locations interconnected by a network.

Those skilled in the art will realize that storage devices utilized to store computer readable instructions may be distributed across a network. For example, a computing device 1030 accessible via network 1028 may store computer readable instructions to implement one or more embodiments provided herein. Computing device 1012 may access computing device 1030 and download a part or all of the computer readable instructions for execution. Alternatively, computing device 1012 may download pieces of the computer readable instructions, as needed, or some instructions may be executed at computing device 1012 and some at computing device 1030.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A system, comprising:
a memory that stores computer-executable components; and
a processor, communicatively coupled to the memory, that facilitates execution of the computer-executable components, the computer-executable components comprising:
a behavior component configured to analyze a set of financial behaviors to determine financial behavior data;
an interaction component configured to facilitate a financial communication related to a modification of the set of financial behaviors;
a measure component configured to determine a financial measure based on the financial behavior data and the financial communication; and
a visualization component configured to visually render the financial measure in a display component.

2. The system of claim 1, wherein the visualization component is further configured to alter the financial measure based on a change in at least one indication that relates to the financial measure from the financial behavior data or the financial communication.

3. The system of claim 1, wherein the computer-executable components further comprise:
a plurality of graphical indicator components that generate respective graphical indications of at least a part of the financial measure.

4. The system of claim 3, wherein the plurality of graphical indicator components respectively measure different aspects of the financial measure related to a trustworthiness score for credit.

5. The system of claim 1, wherein the visualization component is further configured to alter the financial measure based on a change in at least one indication that relates to the financial measure from the financial behavior data or financial data obtained from the financial communication, and to display the change via the display component.

6. The system of claim 1, wherein the computer-executable components further comprise:
a character component configured to measure a set of character variables of a reputation measure as part of the financial measure comprising at least one of a payment punctuality measure, a debt to credit ratio, a loyalty measure, a quality of credit measure, a credit variety measure, a criminal record measure or a public filing measure.

7. The system of claim 1, wherein the computer-executable components further comprise:
a capacity component configured to measure a set of capacity variables of a capacity measure as part of the financial measure comprising at least one of an expense to income ratio, a payment to income ratio, a loan characteristic measure, income source measure, a spending habit measure, or a percentage of credit measure.

8. The system of claim 1, wherein the computer-executable components further comprise:
a collateral component configured to measure a set of collateral variables of a collateral measure as part of the financial measure comprising at least one of an asset measure, cash reserve measure, property evaluation measure, or an asset use measure.

9. The system of claim 1, wherein the computer-executable components further comprise:
a capital component configured to determine a capital measure as part of the financial measure.

10. The system of claim 1, wherein the computer-executable components further comprise:
a conditions component configured to determine a loan condition measure based on an economic status as part of the financial measure.

11. The system of claim 1, wherein the computer-executable components further comprise:
a chat component configured to transmit and receive at least one of textual dialogue, voice dialogue, video content or image content related to the financial communication or the financial behavior data.

12. The system of claim 1, wherein the visualization component is further configured to alter the displayed financial measure based on a change in the financial behavior data.

13. The system of claim 1, wherein the computer-executable components further comprise:
a chronology component configured to generate a chronology of the financial measure with respect to time that is calculated from the financial behavior data and the financial communication and display the chronology via the display component.

14. The system of claim 1, wherein the financial measure comprises a trustworthiness score comprising at least one of a financial credit score number or a financial credit grade.

15. The system of claim 1, wherein the computer-executable components further comprise:
an recommendation component configured to generate a recommendation related to improving the financial measure or at least one variable of the financial measure according to the set of financial behaviors.

16. The system of claim 15, wherein the visualization component is further configured to display a recommendation measure as part of the financial measure based on at least one indication from the financial behavior data or the financial communication of a degree of correlation between the recommendation and the set of financial behaviors.

17. The system of claim 1, wherein the computer-executable components further comprise:
a feedback component configured to generate a set of financial recommendations based on responses obtained from the financial communication and the financial behavior data.

18. The system of claim 1, wherein the computer-executable components further comprise:
a credit risk component configured to determine a credit risk measure as a function of the financial measure, wherein the visualization component renders a visual representation of the credit risk measure at a given time, and modify the credit risk measure based on changes of the financial measure from the financial behavior data and the financial communication.

19. The system of claim 18, wherein the visualization component is further configured to render the financial measure by generating a visual indication corresponding respectively to measures of the financial measure, the measures comprising at least one of the credit risk measure, a recommendation measure, a reputation measure, a capacity measure, a collateral measure, a capital measure or a loan condition measure.

20. The system of claim 1, wherein the financial behavior data is based on one or more financial transactions, and wherein the financial communication comprises a set of exchanges having received communication responses and transmitted communication responses based on the received communication responses.

21. The system of claim 20, wherein the interaction component is further configured to initiate or respond within the financial communication relating to the one or more financial transactions based on a set of financial behavioral options comprising at least one of a suggested financial option, data gathering options, financial questions or a change in the financial measure visually rendered that is based on an updated financial condition.

22. The system of claim 21, wherein the computer-executable components further comprise:
a modification component configured to modify at least one of a tone, a phrase, a language, a dialect, or a grammar construction based on a set of user preferences or personal data learned from the financial communication.

23. The system of claim 20, wherein the computer-executable components further comprise:
a text component configured to communicate the one or more financial transactions in a text based message to a mobile device, wherein the text based message includes a transactional history feed of the one or more financial transactions that are grouped by a grouping according to a set of contacts comprising counterparties that correspond to the one or more financial transactions or according to a set of subject categories of the one or more financial transactions, wherein the grouping is based on a user selection received.

24. The system of claim 23, wherein the transactional history feed comprises a subset of the one or more transactions corresponding to a range of dates or a range of time based on a different user selection.

25. The system of claim 20, wherein the computer-executable components further comprise:
an aggregator component configured to generate a transactional history feed of the one or more financial transactions that is grouped by a grouping according to a set of contacts comprising counterparties to the one or more transactions or according to a set of subject categories of the one or more financial transactions, wherein the grouping is based on a user selection received.

26. The system of claim 23, wherein the computer-executable components further comprise:
a transaction component configured to generate a payment field within the text based message corresponding to a contact of the set of contacts, and initiating a payment within the payment field via the text based message.

27. The system of claim 26, wherein the computer-executable components further comprise:
a confirmation component configured to generate a confirmation message of the payment being processed to the contact.

28. The system of claim 23, wherein the computer-executable components further comprise:
a feedback component configured generate a feedback field for the text based message to receive and publish feedback to the set of contacts and the one or more financial transactions from the text based message.

29. The system of claim 23, wherein the computer-executable components further comprise:
a reward component configured to generate a rewards field of the text based message that communicates a reward stimulus from a contact of the set of contacts based on the one or more transactions.

30. A method, comprising:
analyzing, by a system comprising at least one processor, a set of financial behaviors to determine financial behavior data;
determining a trustworthiness score as a function of financial measures related to the financial behavior data; and
presenting graphical indicators corresponding to the financial measures and the trustworthiness score in a display.

31. The method of claim 30, further comprising:
facilitating a financial communication related to modifying the set of financial behavior, and comprising a set of exchanges having received communication responses and transmitted communication responses based on the received communication responses.

32. The method of claim 31, further comprising:
modifying at least one of a tone, a phrase, a language, a dialect, or a grammar construction based on personal data learned from the financial communication.

33. The method of claim 30, further comprising:
presenting a change in at least one of the graphical indicators corresponding to the financial measures with an explanation of the change with the at least one of the graphical indicators.

34. The method of claim 31, further comprising:
communicating the financial communication based on at least one of the graphical indicators changing according to a change in the financial behavior data or personal data obtained from the financial communication.

35. The method of claim 30, wherein the financial measures comprise at least two of a reputation measure, a credit risk measure, a recommendation measure, a capacity measure, a collateral measure, a capital measure and a loan condition measure.

36. The method of claim 30, further comprising:
communicating a textual dialogue related to the financial behavior data.

37. The method of claim 36, wherein the financial behavior data comprises information related to a financial transaction comprising at least one of a financial contact to the financial transaction, details of the financial transaction, or the graphical indicators.

38. The method of claim 30, further comprising:
generating a chronology of the financial measures according to changes with respect to time and displaying the chronology in the display.

39. The method of claim 30, further comprising:
communicating a financial recommendation related to improving at least one of the financial measures.

40. The method of claim 39, further comprising:
presenting a recommendation measure in the display with at least one of the graphical indicators as a function of the set of financial behaviors corresponding to the financial recommendation.

41. The method of claim 30, wherein the graphical indicators comprise at least one of a visible gauge, a color, a bit number, or a bar indicator.

42. The method of claim 36, wherein communicating the textual dialogue further comprises communicating a set of financial transactions related to the financial behavior data in a text based message, wherein the text based message includes a transactional history feed of the set of financial transactions grouped by a grouping according to a set of contacts comprising counterparties to the set of financial transactions or according to a set of subject categories of the set of financial transactions, wherein the grouping is based on a user selection.

43. The method of claim 42, wherein communicating the textual dialogue further comprises:
communicating a payment field via the text based message; and
initiating a payment via the text based message based on a different user selection to at least one contact of the set of contacts.

44. An apparatus, comprising:
a memory to store computer-executable instructions; and
a processor, communicatively coupled to the memory, that facilitates execution of the computer-executable instructions to at least:
determine financial behavior data from a set of financial behaviors related to a set of financial transactions;
initiate a financial communication related to modifying the set of financial behaviors;
determine a financial measure based on at least one of the financial behavior data or communication responses received from the financial communication; and
present a set of financial variables to the financial measure as graphical indicators in a display.

45. The apparatus of claim 44, wherein the processor further facilitates execution of the computer-executable instructions to:
modify at least one of the graphical indicators in the display based on a change in at least one financial variable of the financial measure.

46. The apparatus of claim 44, wherein the set of financial variables comprise at least one of a character variable related to a character aspect for assessing credit risk, a capacity variable related to a capacity for sustaining credit, a collateral variable related to a collateral for leveraging credit, a capital variable related to a capital threshold, a condition variable related to an economic condition.

47. The apparatus of claim 44, wherein the processor further facilitates execution of the computer-executable instructions to:
generate a chronology of change in the set of financial variables with respect to time; and
display the chronology of change.

48. The apparatus of claim 44, wherein the processor further facilitates execution of the computer-executable instructions to:
communicate a financial recommendation related to improving the financial measure; and
display a recommendation measure based on a degree of correlation identified between the financial recommendation and the set of financial behaviors.

49. The apparatus of claim 44, wherein the processor further facilitates execution of the computer-executable instructions to:
determine a credit risk score or grade as a function of the financial measure.

50. The apparatus of claim 44, wherein the processor further facilitates execution of the computer-executable instructions to:
receive the set of financial transactions in a text based message, wherein the text based message includes a transactional history feed of the set of financial transactions grouped by a grouping according to a set of contacts comprising counterparties that correspond to the set of financial transactions or according to a set of subject categories of the set of financial transactions, wherein the grouping is based on a user selection received.

51. The apparatus of claim 50, wherein the processor further facilitates execution of the computer-executable instructions to:
initiate a payment via the text based message via a selection of a contact of the set of contacts and an amount to pay the contact, and communicate a response to the text based message with the selection.

52. The apparatus of claim 50, wherein the processor further facilitates execution of the computer-executable instructions to:
generate feedback to a contact of the set of contacts or a corresponding transaction from the text based message, and communicate the feedback in the response.

53. The apparatus of claim 50, wherein the processor further facilitates execution of the computer-executable instructions to:
receive a reward stimulus in a rewards field of the text based message that is related to at least one contact or a corresponding transaction of the corresponding transactions.

54. A tangible computer readable medium comprising computer executable instructions that, in response to execution, cause a computing system to perform operations, comprising:
analyzing a set of financial behaviors to determine financial behavior data;
generating a set of recommendations related the set of financial behaviors;
communicating a financial communication having the set of recommendations for modifying the set of financial behaviors; and
presenting a set of graphical indicators that correspond to a set of financial measures based on the set of financial behaviors.

55. The tangible computer readable medium of claim 54, wherein the set of recommendations are generated in response to the financial behavior data determined, and wherein the operations further comprise computing a financial score based on the set of financial measures related to financial behavior data determined after communicating the set of recommendations.

56. The tangible computer readable medium of claim 54, wherein the operations further comprise:
generating a chronology the set of graphical indicators that correspond to the set of financial measures according to changes in the set of graphical indicators with respect to time.
